(19) United States
(12) Patent Application Publication
(10) Pub. No.: US 2014/0188017 A1
(43) Pub. Date: Jul. 3, 2014

(54) SEXUAL STIMULATION DEVICES

(71) Applicant: LOVER HEALTH AND TECHNOLOGY CO., LTD., Huzhou (CN)

(72) Inventor: Wei Wu, Huzhou (CN)

(21) Appl. No.: 13/922,479

(22) Filed: Jun. 20, 2013

Related U.S. Application Data
(63) Continuation of application No. PCT/CN2012/088116, filed on Dec. 31, 2012.

(51) Int. Cl. A61H 19/00; A61H 23/02

(52) U.S. Cl. CPC A61H 19/40; A61H 23/02
USPC 601/46

(57) ABSTRACT

A sexual stimulation device is provided. The stimulation device includes a first pad dimensioned for placement against a pubic area and a second pad dimensioned for placement inside a vagina. The stimulation device also includes a first vibrating motor. The stimulation device further includes a first connecting member and a second connecting member. The first connecting member and the second connecting member connect the first pad and the second pad. The first pad and the second pad may move/vibrate driven by the first vibrating motor.

### CROSS-REFERENCES TO RELATED APPLICATIONS

This application is a continuation of International Patent Application Ser. No. PCT/CN2012/088116 filed on Dec. 31, 2012, the entire contents of which are hereby incorporated by reference.

### FIELD OF INVENTION

The present invention relates to the field of sexual paraphernalia and, more particularly, to sexual stimulation device intended for use by a woman.

### BACKGROUND

There are numerous devices available for use by a woman for sexual stimulation. They include products that are entirely manually operated, and achieve stimulation by shape and/or texture, and products that are provided with internal motors that achieve stimulation by shape, texture and vibration. These devices can generally be used to stimulate only one area at a time. However, it is known that there are at least three distinct effective genital stimulation areas in most women, namely the clitoris and surrounding shell, the inner surface of the vagina and the so-called G-spot, a nerve reflex area inside the vagina, along the anterior surface.

The disclosed stimulation devices are directed at solving one or more problems set forth above and other problems.

### BRIEF SUMMARY OF THE DISCLOSURE

One aspect of the present disclosure provides a sexual stimulation device. The stimulation device includes a first pad dimensioned for placement against a pubic area and a second pad dimensioned for placement inside a vagina. The stimulation device also includes a first vibrating motor. The stimulation device further includes a first connecting member and a second connecting member. The first connecting member and the second connecting member connect the first pad and the second pad. The first pad and the second pad may move/vibrate driven by the first vibrating motor.

Other aspects of the present disclosure can be understood by those skilled in the art in light of the description, the claims, and the drawings of the present disclosure.

### BRIEF DESCRIPTION OF THE DRAWINGS

FIG. 1A illustrates an exemplary device consistent with the disclosed embodiments;

FIG. 1B illustrates an exemplary charger consistent with the disclosed embodiments;

FIG. 2 illustrates a side view of an exemplary device consistent with the disclosed embodiments;

FIG. 3 illustrates a front view of an outer pad of an exemplary device consistent with the disclosed embodiments;

FIG. 4 illustrates a back view of an inner pad of an exemplary device consistent with the disclosed embodiments;

FIG. 5A illustrates an exemplary device consistent with the disclosed embodiments in an open state;

FIG. 5B illustrates an exemplary device consistent with the disclosed embodiments in a close state;

FIG. 6 illustrates an exemplary circuit diagram used in an exemplary device consistent with the disclosed embodiments;

FIG. 7 illustrates the moving directions of an exemplary device consistent with the disclosed embodiments;

FIG. 8 illustrates the moving directions of an exemplary device consistent with the disclosed embodiments;

FIG. 9 illustrates an exemplary circuit diagram for an exemplary remote control consistent with the disclosed embodiments;

FIG. 10 illustrates an exemplary remote control consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

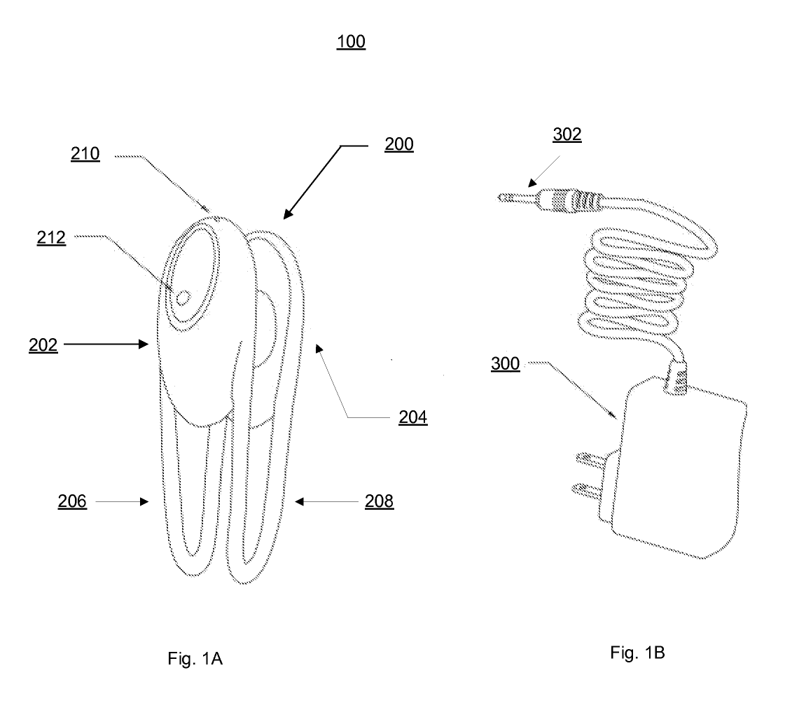

FIGS. 1A and 1B illustrate an exemplary sexual stimulation device 100 consistent with the disclosed embodiments. As shown in FIGS. 1A and 1B, the device 100 includes a stimulator 200 and a charger 300. The stimulator 200 is anatomically shaped and flexible. The stimulator includes an outer pad 202, an inner pad 204, and a connecting structure including a first connecting member 206 and a second connecting member 208.

When the stimulator 200 is in use, the inner pad 204 may lie against regions of the vagina. In certain embodiments, the inner pad 204 is configured to lie against the region of the vagina near which the G-spot is located. The outer pad 202 may lie against the pubic area. In certain embodiment, the outer pad 202 may lie against the clitoris area. The outer pad 202 may have a charging hole 210, which may receive power supply from the charger 300 through a plug 302, and a push button 212.

The stimulator 200 may have an additional connecting member branching from the connecting member 206 or 208. An additional pad may attach to the additional connecting member. The additional connecting member and the additional pad may be so configured that, when the stimulator is in use, the additional pad may lie against a third area of human body, such as anal area. The additional pad may also contain a vibrating motor.

The connecting members 206 and 208 may be in various shapes and sizes. In certain embodiments, the cross section of the connecting members 206 and 208 may be in the shape of an ellipse. The cross-section area of the connecting members 206 and 208 is generally small compared to the cross-section area of the pad 202 and the pad 204. The size of cross section of the connecting members 206 and 208 may be uniform or may vary along the connecting members 206 or 208. The size and shape of the cross sections of the connecting members 206/208 may be configured to minimize the obstruction to the vaginal opening.

The first member 206 and the second member 208 of the connection structure may be connected to the pad 202 and 204 at the two sides close to the bottom of the first pad 202 and the second pad 204. The relative position of the connecting members 206/208 may be configured to minimize the obstruction to the vagina opening and the vagina. That is, the distance between the first connecting member 206 and the second connecting member 208 may be configured to allow the insertion and movement of other objects that may be placed in the vagina. Thus, the stimulator 200 may be worn during a sexual intercourse or other activities and the male sex organ or other objects may enter the vagina and move therein without much obstruction.

The first connecting member 206 and the second connecting member 208 may also be so configured that the stimulator 200 may maintain its position during use. That is, once a user places the stimulator 200 in a position for use, the vibration of the stimulator 200 and/or the body movement of the user and/or the user's partner may not cause the stimulator 200 to substantially relocate from the position the user places the stimulator 200.

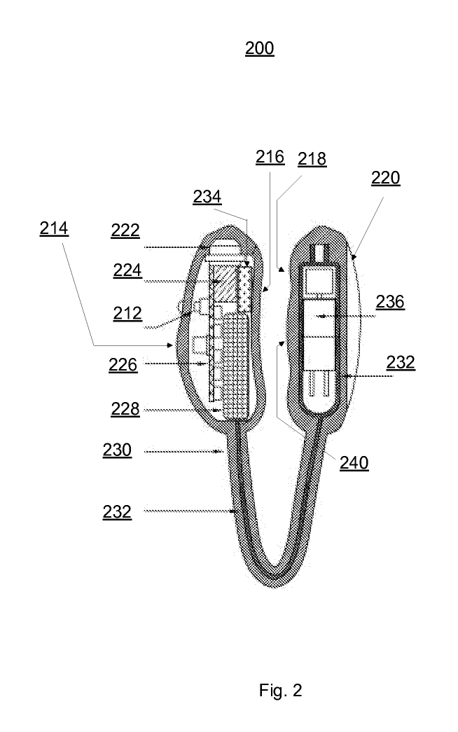

FIG. 2 illustrates a cross-sectional side view of an exemplary stimulator 200 consistent with the disclosed embodiments. As shown in FIG. 2, the stimulator 200 includes an outer shell 230. One or two of the connecting members 206 and 208 may include an inner core 232. The shell 230 forms a shell of the pad 202 enclosing a first chamber and a shell of the pad 204. The shell 230 may be made of silicone, vinyl, rubber, or any other suitable material. The outer surface of the shell 230 may be substantially smooth to allow the smooth movement of other objects in vagina. The outer surface of the shell 230 may also have dimpling, texture or small protrusions features to enhance the stimulation, either to the female user or her partner. The inner core 232 may be made from a shape memory alloy like TiNi, or from a less expensive material, such as an elastic wire, thermoplastic elastomer, or a moulded nylon, polyurethane shell or any other suitable materials. The shell 230 and the inner core 232 may also be made from a combination of any suitable materials.

Within the first chamber, the stimulator 200 may include a waterproof plug 222, a charging socket 224, the push button 212, a printed circuit board assembly (PCBA) 226, a power source 228, and a first vibrating motor 234. Within the shell of the second pad 204, the stimulator 200 may include a second vibrating motor 236.

As shown in FIG. 2, the pad 202 has an outer side 214 and an inner side 216. The pad 204 has an inner side 218 and an outer side 220. When the stimulator is in use, the inner side 216 of the pad 202 may touch against a pubic area of the female user. In certain embodiments, the inner side 216 may touch against the clitoris area. The inner side 218 of the inner pad 204 may touch against a region of the vagina. In certain embodiments, the inner side 218 may touch against the region of the vagina near which the G-spot is located. A user may adjust the stimulator 200 so it may touch various human body parts when it is in use. A bulge 240 may be located approximately at the center of the inner side 218.

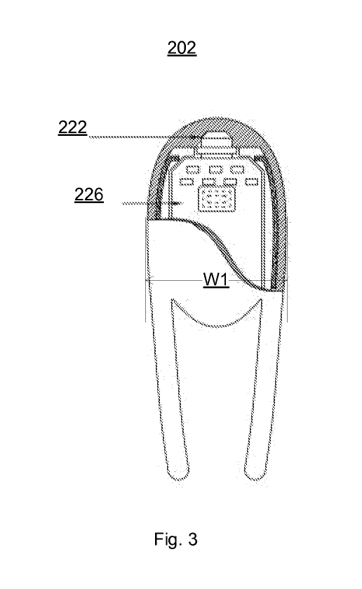

FIG. 3 illustrates a front view of the out pad 204 of an exemplary stimulator consistent with the disclosed embodiments. As shown in FIG. 3, the outer pad 202 may be substantially in a shape of elongated ellipse with a width dimension W1 when viewed from outer side 214 of the stimulator 200. The size of W1 may be adjusted. The outer pad 202 may be in other shapes. The shape and size pad 202 may be configured so that the potential obstruction to the vagina opening and the potential obstruction to activities by the user may be minimized.

When viewed from outer side 214 with the arms 206/208 at the bottom, the waterproof plug 222 is positioned at the top of the first chamber and the PCBA 226 is positioned below the waterproof plug 202. The parts within the first chamber may be configured in other manners.

The first member 206 and the second member 208 of the connection structure may be connected to the pad 202 at the two sides of the pad 202 close to the bottom of the pad 202. Other types of connection structure may also be used. The first member 206 and the second member 208 may be made as integral components of the stimulator 200. They may also be made separately and detachably attached to the pad 202 and the pad 204 during use.

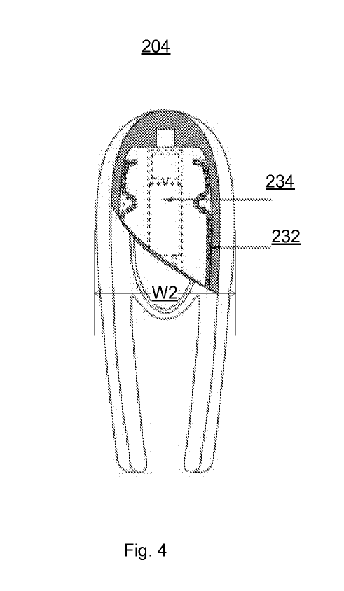

FIG. 4 illustrates a back view of the inner pad 204 of an exemplary stimulator 200 consistent with the disclosed embodiments. As shown in of FIG. 4, the inner pad 204 is substantially in a shape of elongated ellipse with a width dimension W2 when viewed from outer side 220 of the stimulator 200. The size of W2 is substantially similar to that of W1 and may be adjusted. The inner pad 204 may be in other shapes. The shape and size of pad 204 may be configured so that the potential obstruction to the vagina opening and the potential obstruction to other activities may be minimized.

As shown in FIG. 4, the inner core 232 may extend under the shell of the pad 204 to facilitate the attachment of the second vibrating motor 236 to the pad 204. The second vibrating motor 236 may also be attached to the pad 204 through other methods. For example, the motor 236 may be made as an integral component of the pad 204. The first member 206 and the second member 208 are connected to the pad 204 at the two sides of the pad 204 close to the bottom of the pad 204.

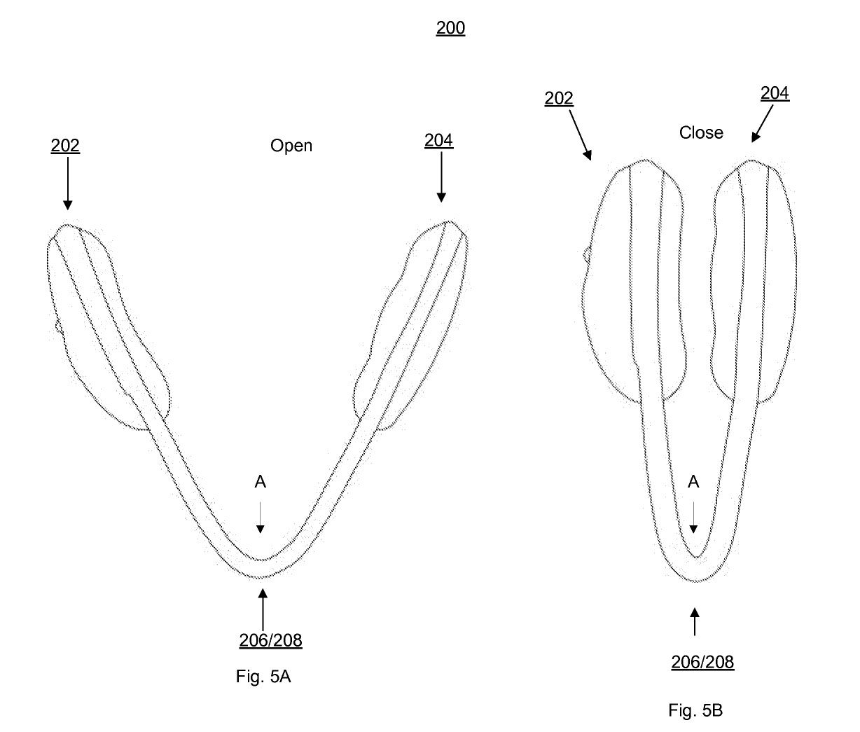

FIGS. 5A and 5B illustrates an exemplary stimulator 200 consistent with the disclosed embodiments. As shown in FIG. 5A, the stimulator 200 may be in an open state. The members 206/208 generally form a “V” or “U” shape when the stimulator 200 is viewed from one side. When the stimulator 200 is in an open state, the angle A formed by the two arms of the “V” form is relatively larger and the pads 202 and 204 are separated from each other farther. As shown in FIG. 5B, when the stimulator 200 is in a close state, the angle A formed by the two arms of the “V” form is relatively smaller and the pads 202 and 204 are closer to each other. The two arms of the “V” may be adjusted so the angle A may be any angle between 0° and 180°.

The shell 230 and the core 232 may be made from materials that are flexible enough to be bent or extended and may also be sufficiently rigid to maintain the shape. Therefore, a user may adjust the angle A of the “V” without much difficulty. Meanwhile, the “V” shape may not be easily deformed during use of the stimulator 200. That is, the angle A of the “V” may be substantially maintained while one or two of the two pads 202 and 204 vibrate. When the stimulator 200 is in use and rubs against human body parts, sometimes quite vigorously, the angle A of the V may also be substantially maintained.

A user may adjust the angle of the “V” so the inner pad 204 makes contact with certain region within the vagina, and the outer pad 202 makes contact with the pubic area. In certain embodiment, the inner pad 204 may contact the region near where the G-spot is located and the outer pad 202 may contact the clitoris area. The stimulator 200 may be configured so a portion of one or two of the first connecting member 206 and the second connecting member 208 may make contact with the front wall of the vagina when the inner pad 204 is inserted into the vagina to make contact with certain region within the vagina. The core 232 may be made of material that is resilient enough that the core 232 may push the pads 202 and 204, and or the connecting members 206 and/or 208 against the body areas that they make contact with. The shell 230 and the core 232 may also be hard enough to protect the components and circuitry located therein.

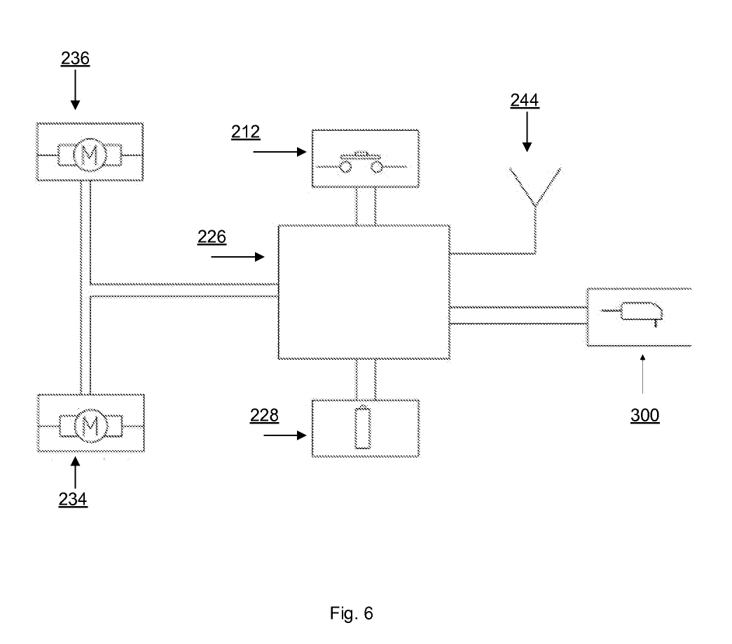

FIG. 6 illustrates an exemplary circuit diagram of an exemplary stimulator 200. As shown in FIG. 6, the circuit connects the push button 212, the PCBA 226, the power source 228, the first vibrating motor 234, the second vibrating motor 236, and a receiver antenna 240. The circuit may also connect to the charger 300. In certain embodiment, the PCBA 226, the power source 228, and the first vibrating motor 234 are located within the pad 202. The electrical connection between the PCBA 226, the power source 228, and the first vibrating motor 234 may be through pre-fabricated wire connection. The second vibrating motor 236 may be electrically connected to the circuit though the inner core 232 if the inner core 232 is made of a conductive material, or though a separate conductive wire whether the inner core 232 is made of a conductive or a non-conductive material.

The first vibrating motor 234 and the second vibrating motor 236 are under the control of the PCBA 226. The PCBA 226 may turn on the first vibrating motor 234 and the second vibrating motor 236 simultaneously. The PCBA 226 may also only turn on one of the two vibrating motors 234 and 236 or turn off both of the two vibrating motors 234 and 236 as a user chooses. A user may choose to move/vibrate the pads 202 and/or 204 through mechanic means when the motors 234 and/or 236 are turned off.

The PCBA 226 may be pre-programmed for a variety of vibrating patterns to control the direction, frequency, and strength of the vibration of the different components of the stimulator 200, such as pad 202 and/or 204, and/or connecting members 206/208. The motors 234 and 236 may be configured to vibrate along various directions and dimensions and with various frequency and strength. The PCBA 206 may choose the same pattern for both motor 234 and 236. For example, the motor 234 and 236 may vibrate along the same direction with same frequency and/or strength. The PCBA 206 may also choose different pattern for motor 234 and 236. For example, the motor 234 and 236 may vibrate along different direction with different frequency and/or strength. The PCBA 206 may choose any combination of the vibration mechanisms for the two motor 234 and 236. The vibrating signal generated by the PCBA 206 may be transmitted to the motor 234 and 236 through the same electrical transmitting wire or a separate signal transmitting wire.

A user may select different vibrating pattern and the combinations of various vibrating patterns by pressing the push button 212. A user may also control the motors 234 and 236 through a remote. The circuit board assembly may receive signal from a remote through the receiver antenna 240 and control the vibrating motors 234 and 236 accordingly. The circuit and the motors of the stimulator 200 are powered by the power source 228. The power source 228 may or may not be rechargeable cell and, if rechargeable, may be recharged by receiving electricity from the charger 300 through the plug 302.

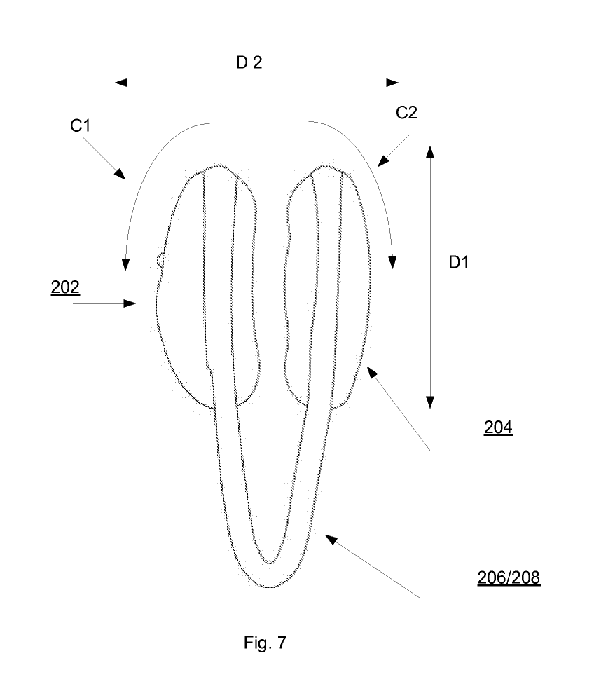

Under the drive of the motors 234 and 236, the pad 202 and the pad 204 may move/vibrate along different directions and/or dimensions. As shown in FIG. 7, the pads 202/204 and/or the connecting members 206/208 may move/vibrate along the first direction D1. The pad 202/204 may move/vibrate along the second direction D2. The first direction D1 and the second direction D2 may form any angle between 0° C. and 90° C. The pad 202 and the pad 204 may or may not move synchronously. Similarly, the connecting member 206 and 208 may or may not move synchronously. The pad 202, the pad 204, the connecting members 206/208 may move/vibrate in a clockwise direction C2, or in a count-clockwise direction C1. The movement/vibration of the various components of the stimulator 200 may be one of various combinations of patterns.

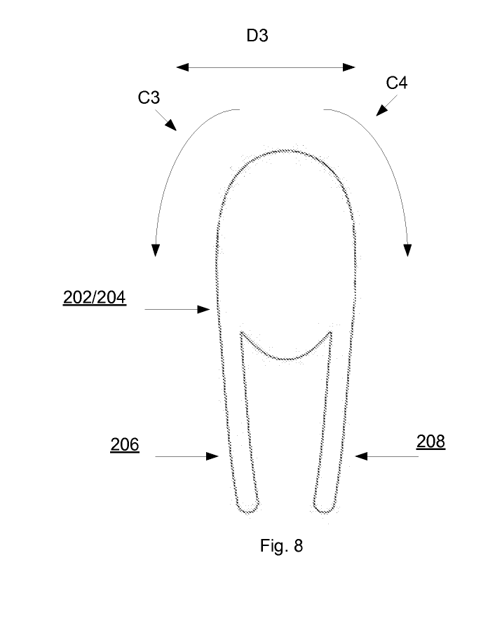

As shown in FIG. 8, the pad 202, the pad 204, and/or the connecting members 206/208 may move/vibrate along the third direction D3. The pad 202, the pad 204, and/or the connecting members 206/208 may move/vibrate circularly in a clockwise direction C4, or in a count-clockwise direction C3. Different component may move in a same direction, or in different directions. The movements/vibrations of the pad 202, the pad 204, and/or the connecting members 206/208 in the dimension as shown in FIG. 8 may form various combinations with the movement/vibration in the dimension as shown in FIG. 7.

Thus, the PCBA 226 may generate a first vibrating pattern for the outer pad 202, a second vibrating pattern for the inner pad 204, a third vibrating pattern for the connecting member 206, and a fourth vibrating pattern for the connecting member 208. The first, second, third, and fourth vibrating pattern may or may not be the same.

The materials for making the shell 230 and/or the core 232 may be of such a property to allow the vibrations of the pads 202 and/or 204, and/or the connecting members 206 and/or 208, as driven by the motors 234 and 236. For example, the shell 230 may be flexible enough to permit the pad 202 and 204 move along the first direction D1, the second direction D2, and the third direction D3. When vibrating, the pads 202/204 may move/vibrate longitudinally, transversely, vertically, and/or circularly along any directions and/or dimensions. The members 206/208 may also move/vibrate along any dimensions and/or directions as the vibrating signal may be transmitted to the connecting members 206/208. In the meantime, the shape of the stimulator 200 may be substantially maintained during vibration.

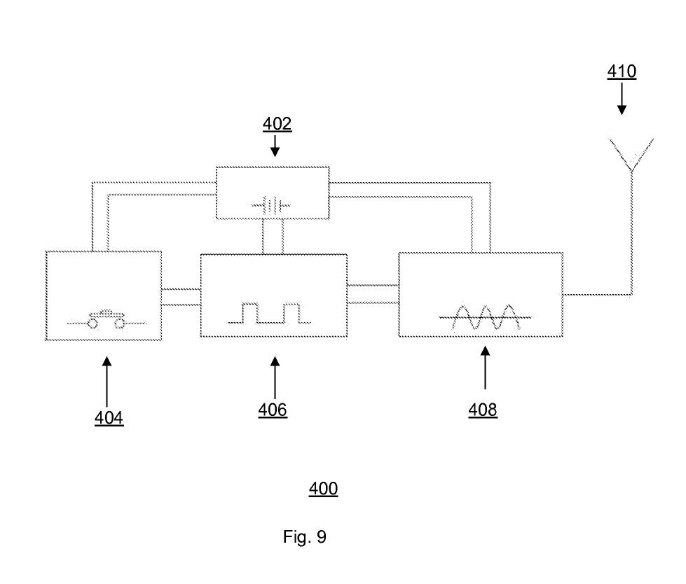

FIG. 9 illustrates an exemplary circuit diagram of an exemplary remote 400. As shown in FIG. 9, the circuit of the remote 400 includes a remote power source 402, a remote push button 404, a remote printed circuit board assembly (PCBA) 406, a remote transmitter circuit 408, and a transmitter antenna 410.

The remote PCBA 406 may be configured to generate a controlling signal for certain vibrating patterns or combinations of various vibrating patterns on the stimulator 200. A user can select the controlling signals generated by remote PCBA 406 by pressing the push button 404.

The controlling signal generated by the remote PCBA 406 is sent to the transmitter circuit 408, which transform the controlling signal into an electromagnetic signal. The electromagnetic signal is transmitted through the transmitter antenna 410 and received through the receiver antenna 240 by the PCBA 226 in the stimulator 200. After receiving the signal, the PCBA 226 may generate vibrating pattern or a combination of various patterns according the signal. The vibrating pattern or the combination of various patterns that are ultimately controlled by the remote PCBA 406 may be similar to the vibrating pattern generated by PCBA 226 as described above. The remote circuit of the remote 400 may be powered by the power source 402, which may or may not be a rechargeable cell.

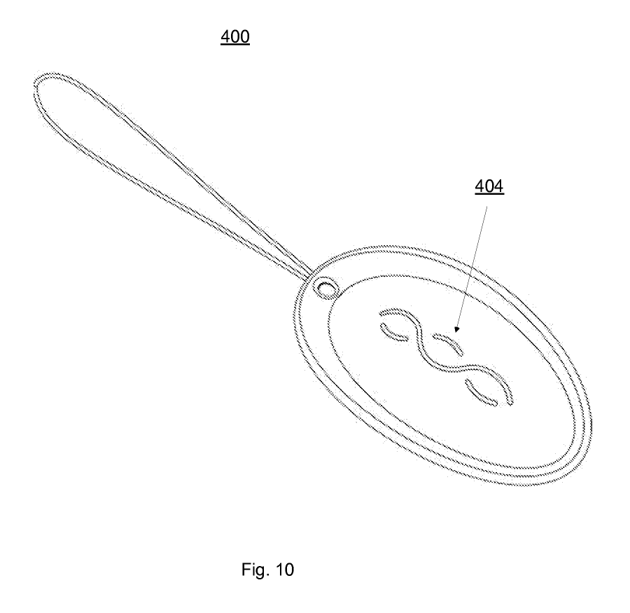

FIG. 10 illustrates an exemplary remote 400 consistent with the disclosed embodiments. The remote 400 may be made in the shape of a decorative object. The push button 404 may be made in a shape of an accessory part on the decorative object.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications. For example, the stimulator 200 may be made in different sizes to adjust the need of different persons. The remote 400 may be made in the shape of different objects.

What is claimed is:

1. A sexual stimulation device comprising:
a first pad dimensioned for placement against a pubic area;
a second pad dimensioned for placement inside a vagina;
a first vibrating motor;
a first connecting member; and
a second connecting member, wherein:
the first connecting member and the second connecting member connect the first pad and the second pad, and
the first pad and the second pad may move/vibrate driven by the first vibrating motor.

2. The stimulation device of claim 1, further comprising an inner core, wherein:
the inner core is made of a material that can be configured to exert pressure upon the human body areas the first pad and the second pad lie against when the device is in use.

3. The stimulation device of claim 2, wherein the inner core is made of a material selected from the group consisting of a shape memory material, an elastic wire, a thermoplastic elastomer, a moulded nylon, a polyurethane shell and combination thereof.

4. The stimulation device of claim 1, further comprising:
a second vibrating motor, wherein:
the first pad and the second pad may move/vibrate driven by at least one of the first vibrating motor and the second vibrating motor.

5. The stimulation device of claim 4, wherein:
the first vibrating motor is located within the first pad; and
the second vibrating motor is located within the second pad.

6. The stimulation device of claim 1, wherein:
the first connecting member and the second connecting member are in a shape substantially resembling the letter “V”.

7. The stimulation device of claim 1, further comprising a power source.

8. The stimulation device of claim 7, wherein the power source is a rechargeable battery.

9. The stimulation device of claim 1, further comprising a switch push button.

10. The stimulation device of claim 1, further comprising a printed circuit board assembly (PCBA)

11. The stimulation device of claim 10, wherein the PCBA is pre-programmed to generate a vibrating pattern.

12. The stimulation device of claim 11, wherein the PCBA is pre-programmed to generate a first vibrating pattern for the first pad, a second vibrating pattern for the second pad, a third vibrating pattern for the first connecting member, and a fourth vibrating pattern for the second connecting member.

13. The stimulation device of claim 7, further comprising a remote.

14. The stimulation device of claim 13, wherein the remote includes a remote PCBA.

15. The stimulation device of claim 14, wherein the remote PCBA is pre-programmed to generate a vibrating pattern.

16. The stimulation device of claim 1, wherein the first connecting member and the second connecting member are configured to minimize the obstruction to the vagina opening.

17. The stimulation device of claim 1, wherein the first pad is dimensioned for placement against clitoral area.

18. The stimulation device of claim 1, wherein the second pad is dimensioned for placement against the region of vagina near which the G-spot is located.

19. The stimulation device of claim 1, wherein one of the first connecting member and the second connecting member are configured to be in contact with the front wall of a vagina when the second pad is inserted into the vagina.

20. The stimulation device of claim 19, wherein the inner core is made of a material that can be configured to exert pressure upon the human body areas the first connecting member and the second connecting member contact with when the device is in use.
